(19) United States
(12) Patent Application Publication
(10) Pub. No.: US 2013/0214446 A1
(43) Pub. Date: Aug. 22, 2013

(54) METHOD OF FORMING RESIN MOLDED PRODUCT

(71) Applicants: SUZUKI MOTOR CORPORATION, (US); Takahisa EGAWA, Shizuoka-Ken (JP)

(72) Inventor: Takahisa EGAWA, Shizuoka-Ken (JP)

(73) Assignees: SUZUKI MOTOR CORPORATION, Shizuoka-Ken (JP); Takahisa EGAWA, Shizuoka-Ken (JP)

(21) Appl. No.: 13/767,975

(22) Filed: Feb. 15, 2013

(30) Foreign Application Priority Data
Feb. 22, 2012 (JP) 2012-035717

(51) Int. Cl. B29C 44/02

(52) U.S. Cl. CPC B29C 44/02
USPC 264/54

(57) ABSTRACT

A method of molding a resin molded product wherein a resin material in a molten state containing a forming agent is injected through a gate into a cavity of molding die thereby forming the form-molded product, wherein the gate communicating with the cavity of the molding die is continuously formed to the rising wall portion of the foam-molded product; the rising wall portion is provided with a rib at a position apart from the gate at a predetermined distance; a foaming of the molten resin material injected from the gate into the cavity is suppressed at a region corresponding to the upstream side portion of the foam-molded product, while the foaming of the molten resin material is promoted at a region corresponding to the downstream side portion of the foam-molded product.

### PRIORITY CLAIM

This patent application claims priority to Japanese Patent Application No. 2012-035717, filed 22 Feb. 2012, the disclosure of which is incorporated herein by reference in its entirety.

### BACKGROUND OF THE INVENTION

1. Field of The Invention

The present invention relates to a method of forming a resin molded product provided with a rib through an injection molding method.

2. Related Art

In recent years, in order to reduce carbon dioxide (CO₂) exhausted from vehicles such as automobile or the like, an improvement in a fuel-efficiency has been technically demanded and it becomes essential to reduce weight of the vehicle. As a part of approach to reduce the weight of the vehicle, there has been conventionally proposed a method in which interior resin parts of the automobile or the like are formed to have thin-wall structure thereby to reduce the weight of the resin parts. However, when the product (interior resin molded product, resin part) is formed to have a thin-wall structure, it becomes difficult to secure a sufficient rigidity of the product.

Therefore, as a method for securing the sufficient rigidity while reducing the weight of product, there has been known a method in which an injection foam molding method is applied as disclosed in the Japanese Patent Laid-Open Publication No. 2005-271499. In this disclosed injection foam molding method, for example, a pair of openable and closable molding dies are applied. In a state where the both molding dies are assembled, a molten resin material to which a foaming agent is added is injected into the molding dies. Thereafter, one side of the molding dies is slightly opened at a predetermined opening degree and the both molding dies are apart from to each other (hereinafter refers to as “core back operation”) whereby the injected resin material is foamed. According to this method, since a wall-thickness of the resin molded product (formed molding product) becomes thick, a sufficient rigidity can be secured in comparison with a case where the resin molded product is formed to have a thin wall thickness and a light weight.

On the other hand, in an ordinary injection molding method in which an injection molding operation is performed without adding the foaming agent to the resin material, the resultant resin molded product is provided with a rib so as to secure the sufficient rigidity of the resin molded product.

However, when the rib is provided, there may be arisen a problem such that a dent (sink) is generated at a portion close to the rib due to contraction (shrinkage) of the resin material at a time of molding the resin material, depending on dimension (size) of basic wall thickness of the resin molded product or size of width of a root portion of the rib.

In contrast, in case of the above injection foam molding method, the root portion of the rib is also foamed (foam formation) due to the core back operation, so that there can be obtained an advantageous effect such that the above dent and sink are not generated at all.

However, in a case where the resin molded product has a box-shape in which rising wall portions are provided so as to rise from a bottom surface portion, and the bottom surface portion is vertically positioned with respect to a core back direction while the rising wall portions are positioned to be parallel with the core back direction at a time of injection foam molding operation by the core back, thickness of these rising wall portions cannot be increased even if the core back operation is performed.

Accordingly, when a rib is provided to this rising wall portion, the resin material is hardly foamed at a root portion of the rib, so that there may arise a disadvantage such that the sink is generated to a portion close to the rib (refer to “sink 7” shown in FIG. 6B).

Further, in the injection foam molding method, an injection pressure is released at a moment when the resin material in a molten state is injected from a gate of the molding die into a cavity of molding dies, then the injected resin material starts to foam. Therefore, the molten resin material injected into the molding dies flows and fluidizes within the molding dies while foaming.

However, at this time, a scar (swirl mark) having silver-white color is generated at a surface of the resin molded body due to a rupture of bubble. Further, in the flowing and fluidizing process of the molten resin material, when air is involved into the molten resin material, the sink (recess) is generated at the surface of the resin molded body, thus resulting in poor appearance defect.

### SUMMARY OF THE INVENTION

The present invention has been conceived in consideration of the above circumstances, and an object of the present invention is to provide a method of forming a resin molded product provided with a rib through an injection molding method, which is capable of preventing the generation of sink at a portion close to the rib of the resin molded product.

This and other objects of the present invention can be achieved according to the present invention by providing a method of molding a resin molded product in which a resin material in a molten state containing a forming agent is injected through a gate into a cavity of molding die thereby to form the resin molded product, wherein the gate communicating with the cavity of the molding die is continuously formed to a portion of the resin molded product; the resin molded product is provided with a rib at a position apart from the gate at predetermined distance, and a thickness of an upstream side portion ranging from the gate to the rib is thinner than a thickness of a downstream side portion ranging from the rib and extending in a direction opposing to the gate; and a foaming of the molten resin material injected from the gate into the cavity is suppressed at a region corresponding to the upstream side portion of the resin molded product, while the foaming of the molten resin material is promoted at a region corresponding to the downstream side portion of the resin molded product.

According to the above present invention, the foaming of the molten resin material injected from the gate into the cavity is suppressed at the region corresponding to the upstream side portion of the resin molded product, while the foaming of the molten resin material is promoted at the region corresponding to the downstream side portion of the resin molded product, so that the molten resin material effectively foams at a root portion of the rib, whereby the generation of the sink at the portion close to the rib of the resin molded product can be effectively prevented.

In a preferred embodiment of the above aspect, it may be desired that the resin molded product is molded in the cavity under a condition that the thickness of the upstream side portion of the resin molded product or the rising wall portion is set to be larger than a width of the root portion of the rib.

According to the above structure and condition, the generation of the sink at the portion close to the rib of the resin molded product can be more effectively prevented. Namely, when the thickness of the upstream side portion of the resin molded product or the rising wall portion is smaller than the width of the root portion of the rib. A power of foaming is weak, so that the foam-formation cannot be performed at the root portion of the rib.

For example, in a case where the width tC of the root portion of the rib is set to 1.2 mm as described in Example while the thickness tA of the upstream side portion of the resin molded product or the rising wall portion is set to be smaller than the width tC of the root portion of the rib, a flowability (fluidizing property) of the molten resin material is deteriorated, so that there may be posed a disadvantage that the molten resin material cannot be injected into the cavity.

In another preferred embodiment of the above aspect, it is more preferable that the resin molded product is molded in the cavity under a condition that a difference between the thickness of the upstream side portion of the resin molded product or the rising wall portions and a thickness of the downstream side portion is set to be 0.5 mm or more.

According to the above condition, a more remarkable effect of preventing the generation of the sink can be obtained. Namely, when the difference in thickness between the upstream side portion of the resin molded product or the rising wall portions and the downstream side portion is less than 0.5 mm, it is difficult to form the foaming at the root portion of the rib, so that the generation of the sink cannot be improved.

In general, as the pressure reducing rate of the injected molten resin material becomes large, the foam formation is effectively advanced.

In this regard, as the difference in thickness becomes large, a more rapid pressure change of the injected resin material is generated. This rapid pressure change is preferable for the foam-formation. When the molten resin material fluidizes at the root portion of the rib, the pressure change of the molten resin material is generated. However, such pressure change is insufficient.

To remove the above disadvantage, when the thickness of the downstream side portion ranging from the rib is set to be relatively thick, the foam formation at the root portion of the rib can be performed more easily, so that the generation of the sink can be prevented.

In still another preferred embodiment of the above aspect, it is more preferable that the resin molded product is molded in the cavity under a condition that the thickness of the upstream side portion of the resin molded product or the rising wall portions is set to be 1.5 mm or less.

According to the above condition, the foaming (foam formation) of the resin material at the region corresponding to the upstream side portion of the rising wall portion in the cavity can be more steadily suppressed so that the generation of the sink can be more effectively prevented.

As described above, when an abrupt change in thickness is generated, the foam formation is promoted. Therefore, when the thickness of the upstream side portion of the resin molded product or the rising wall portions is set to be 1.5 mm or less, the foam formation can be effectively suppressed.

The nature and further characteristic features of the present invention will be made clearer from the following descriptions made with reference to the accompanying drawings.

### BRIEF DESCRIPTION OF THE DRAWINGS

In the accompanying drawings:

FIGS. 1A-1E are operational views explaining operations of a method of molding a resin molded product to which one embodiment of the method of molding a resin molded product according to the present invention is applied;

FIG. 2 is a cross sectional view showing a molding die at a die-clamping (closing) process shown in FIGS. 1A-1E;

FIG. 3 is a cross sectional view showing a molding die at an injection process shown in FIGS. 1A-1E;

FIG. 4 is a cross sectional view showing a molding die at a core back process (core back operation) and cooling process shown in FIGS. 1A-1E;

FIG. 5 is a perspective view showing a foam-molded product shown in FIGS. 1A-1E;

FIG. 6 is a plan view of the resin molded body taken along the line VI in FIG. 5, FIG. 6A is a plan view of one embodiment of the resin molded body according to the present invention, and FIG. 6B is a plan view of a resin molded body of conventional example;

FIG. 7 is a diagram showing specification of a mold injection machine shown in FIG. 3;

FIG. 8 is a diagram comparatively showing shapes of the foam-molded products according to the example and the conventional example shown in FIG. 5;

FIG. 9 is a diagram showing molding conditions at the core back process; and

FIG. 10 is a diagram comparatively showing outer configurations and sink-generation status of the foam-molded products of Example and Conventional Example.

### DESCRIPTION OF THE PREFERRED EMBODIMENTS

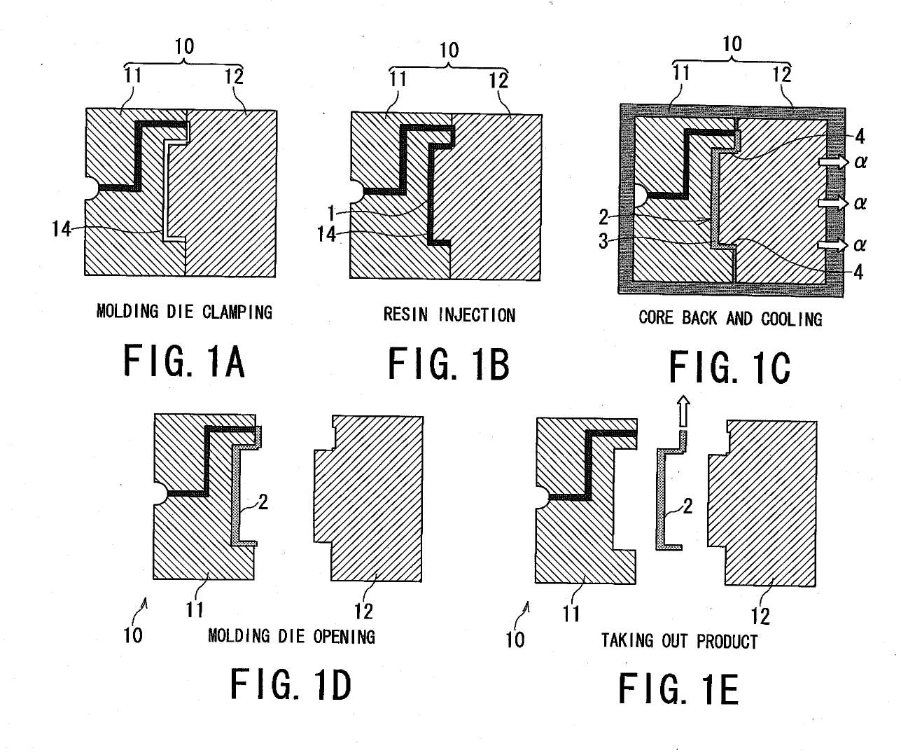

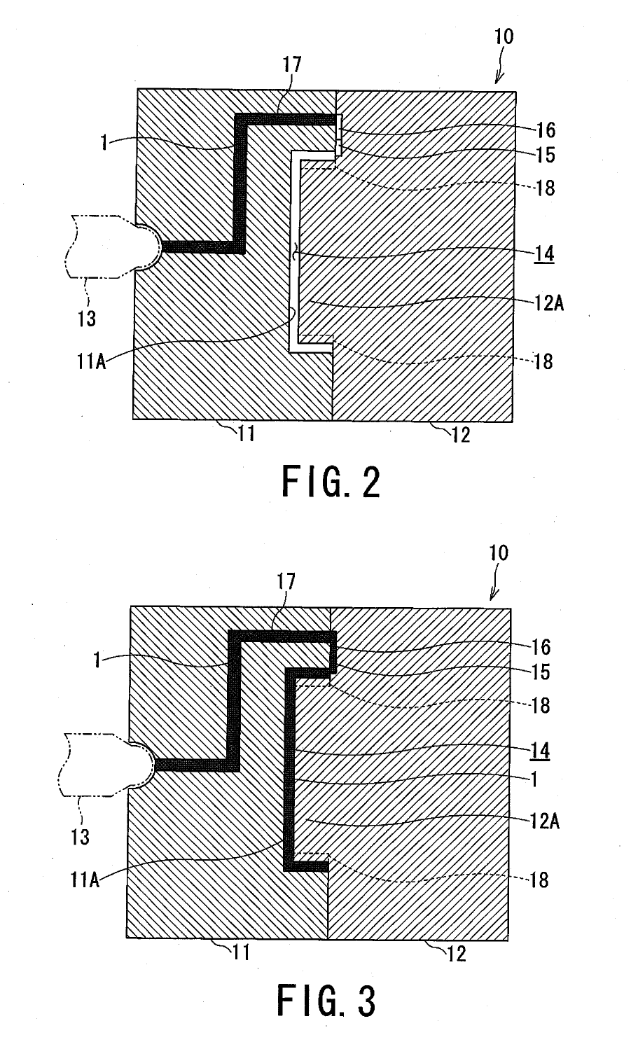

A preferred embodiment for embodying the present invention will be described hereunder based on the attached drawings. FIGS. 1A-1E are operational views explaining operations of a method of molding a resin molded product to which one embodiment of the method of molding a resin molded product according to the present invention is applied. FIG. 2 is a cross sectional view showing a molding die at a die-clamping process shown in FIGS. 1A-1E.

As shown in FIG. 1A and FIG. 2, a molding die 10 used in this embodiment is configured by comprising: a fixed die 11 to which a resin material 1 in molten state is supplied; and a movable die 12 which is provided so as to be movable with respect to the fixed die 11.

The fixed die 11 is configured as a block body having a concave shape as a whole. For example, the fixed die is formed to have a shape in which a recessed portion 11A is provided at a center portion of the fixed die 11. On the other hand, the movable die 12 is configured as a block body having a convex shape in cross section, and the cross section has a convex portion 12A having a convex shape into which the concave portion 11A of the fixed die 11 can be fitted. A transfer amount (travel distance) of the movable die 12 with respect to the fixed die 11 is configured so as to be controllable.

At a joint portion of the fixed die 11 and the movable die 12, i.e. a portion between the recessed portion 11A of the fixed die 11 and the convex portion 12A of the movable die 12 is formed with a cavity 14 for injection foam molding. Further, in the movable die 12, a gate 15 and a cold runner 16 are sequentially and continuously formed to the cavity 14. In contrast, in the fixed die 11 is formed with a hot runner 17 which is continuously connected to the cold runner 16. As shown in FIG. 2, an injection molding machine 13 is connected to the hot runner 17 so as to be communicated to each other. At a connecting position of the hot runner 17 and the cold runner 16 is provided with a valve pin (not shown) for controlling a fluidization of the resin material 1 in a molten state.

The mold injection machine 13 prepares a resin material such that, for example, a chemical foaming agent such as sodium hydrogen carbonate or the like is added to a thermoplastic resin such as polypropylene or the like thereby to prepare a mixture, and the mixture is heated thereby to prepare the resin material in a molten state.

The resin material 1 in a molten state to which the foaming agent is added is injected from the mold injection machine 13 and sequentially passed through the hot runner 17, the cold runner 16 and the gate 15, then injected into the cavity 14, so that the cavity 14 is filled with the resin material 1. The resin material 1 injected into the cavity 14 is foamed by the foaming agent and molded as described later on, thereby to form a foam-molded product 2 as the resin molded product.

A process of the foam molding for forming the foam-molded product 2 will be explained hereunder by mainly referring FIGS. 1A-1E. Firstly, the molding die 10 comprising: the fixed die 11; and the movable die 12 is clamped and closed (FIG. 1A and FIG. 2). Next, under this clamped (closed) state, the resin material 1 containing the foam agent and supplied from the injection molding machine 13 is injected into the cavity 14 of the molding die 10 thereby to fill the cavity 14 with the resin material 1 (FIG. 1B and FIG. 3).

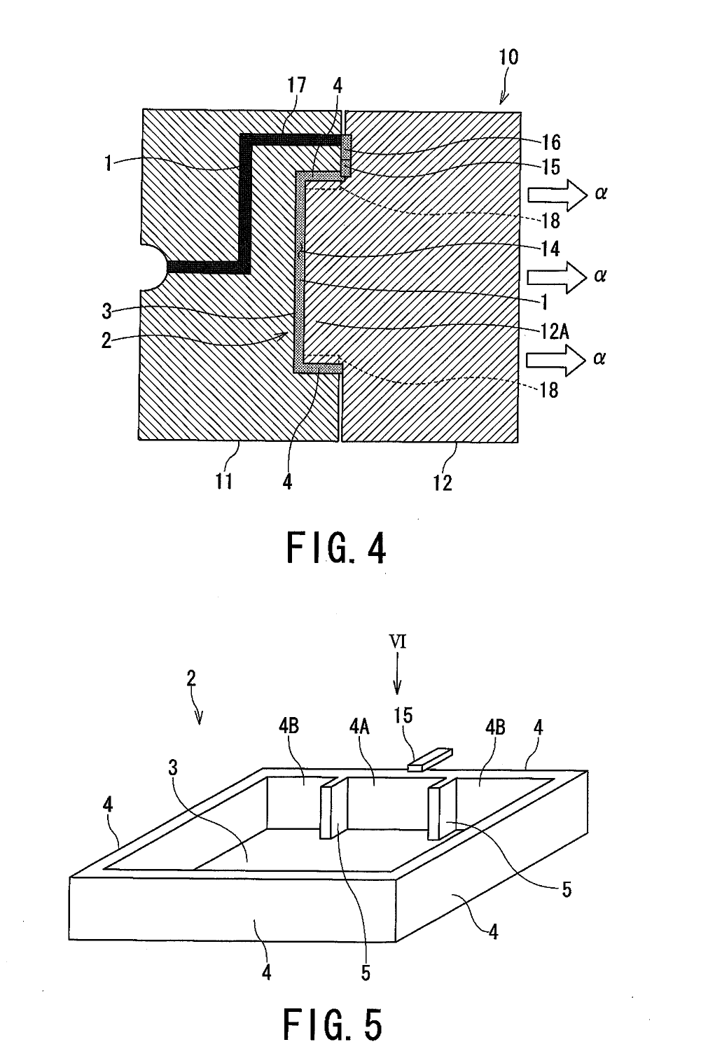

Thereafter, the movable die 12 is pulled apart (core back) with respect to the fixed die 11 in a direction indicated by an arrow α at a predetermined amount of distance, the resin material 1 filled in the cavity 14 is foamed by the action of the foaming agent, and after completion of the core back operation, the foamed resin material is cooled (FIG. 1C and FIG. 4).

After completion of the cooling process, the movable die 12 is further pulled apart from the fixed die 11 (FIG. 1D). Then, the foam molded product 2 molded in the cavity 14 is taken out from the molding die 10 (FIG. 1E).

In this connection, as shown in FIG. 5, the foam-molded product 2 molded by the above injection foam-molding process is a molded body having a box-shape comprising; a bottom surface portion 3; and a rising wall portion 4 which is risen from a periphery of the bottom surface portion 3, and the box-shaped molded body is used as a door trim board or a backdoor trim of a four-wheeled vehicle (automobile). Further, as shown in FIGS. 2, 4 and 5, the gate 15 of the molding die 10 is provided to the molding die 10 so as to be continuous to the rising wall portions 4 of the foam-molded product 2.

Furthermore, as shown in FIGS. 1C and 4, the rising wall portions 4 of the foam-molded product 2 are risen from the bottom surface portion 3 in parallel with the pulling-apart direction (arrow α direction) along which the movable die 12 is pulled apart from the fixed die 11 during the core back operation. Accordingly, this rising wall portion 4 becomes a portion of which thickness is not increased even if the core back operation is performed.

Therefore, in order to secure a rigidity of this rising wall portion 4, as shown in FIG. 5, the rising wall portion 4 is provided with a rib 5 at a portion apart from the gate 15 by a predetermined distance. By the way, a reference numeral 18 shown in FIGS. 2 to 4 denotes a recessed portion for forming rib (rib-forming recessed portion 18) to the rising wall portion 4, and the rib-forming recessed portion 18 is formed and provided as a part of the cavity 14 to the movable die 12.

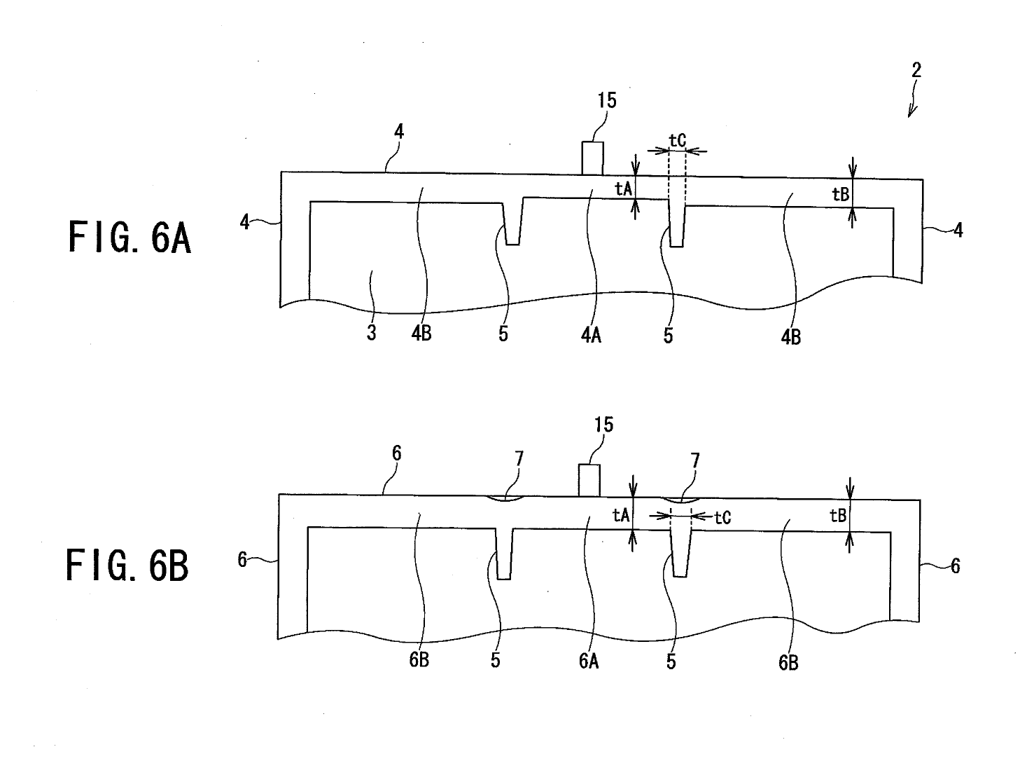

However, as already mentioned above, the rising wall portion 4 is a portion of which thickness is not sufficiently increased even if the core-back operation is performed, so that the resin material 1 is difficult to foam particularly at a root portion of the rib 5. As a result, as shown in FIG. 6B, in a conventional rising wall portion 6 having a uniform thickness in entire wall portion, a sink (recess) 7 is disadvantageously generated particularly at a portion close to the rib 5.

In contrast, particularly in the present embodiment, for the purpose of preventing the generation of the sink 7, as shown in FIG. 6A, the rising wall portion 4 of the foam-molded product 2 is configured such that a thickness tA of an upstream side portion 4A (not including the rib 5) ranging from the gate 15 to the rib 5 is set to be thinner than a thickness tB of a downstream side portion 4B (including the rib 5) ranging from the rib 5 and extending in a direction opposing to the gate 15. Namely, each of the thickness satisfies a relation; tA<tB.

As described above, the thickness tA of the upstream side portion 4A is set to be thinner than the thickness tB of a downstream side portion 4B in the rising wall portion 4. Therefore, in a region corresponding to the upstream side 4A (shown in FIG. 6A) of the rising wall portion 4, and at a portion around the gate 15 in the cavity 14, an abruptly lowering of a resin injection pressure is suppressed at the resin injection process shown in FIG. 1B and FIG. 3, so that a foaming (foam formation) of the resin material 1 injected from the gate 15 into the cavity 14 in a molten state is suppressed at the region corresponding to the upstream side 4A of the rising wall portion 4, whereby the generation of the swirl mark and pit, that are particular and inherent defects for a conventional injection-foam molding method, can be effectively reduced.

In contrast, in a region corresponding to the downstream side portion 4B of the rising wall portion 4 in the cavity 14, a pressure reducing rate becomes large at the resin injection process shown in FIG. 1B and FIG. 3, so that the foaming of the resin material 1 injected in the cavity 14 in a molten state is promoted at the region corresponding to the downstream side 4B. Particularly, the foaming of the resin material 1 is promoted at the root portion of the rib 5, so that the generation of the sink 7 (shown in FIG. 6B) can be effectively prevented at a portion close to the rib 5 provided to the rising wall portion 4.

More concretely, in another embodiment, it is preferable that a difference between the thickness tA of the upstream side portion 4A of the rising wall portion 4 in the foam-molded product and a thickness tB of the downstream side portion 4B is set to 0.5 mm or more.

Further, it is also preferable that the thickness tA of the upstream side portion 4A of the rising wall portion 4 is set to be larger than a width tC of the root portion of the rib 5. Namely, the thickness satisfies a relation: (tA>tC).

Furthermore, for the purpose of more steadily suppressing the foaming (foam formation) of the resin material at the region corresponding to the upstream side portion 4A of the rising wall portion 4 in the cavity 14, it is also preferable that the thickness tA of the upstream side portion 4A of the rising wall portion 4 is set to be 1.5 mm or less.

Next, an Example to which the present embodiment is applied will be explained hereunder in comparison with a Conventional Example to which a conventional prior art technique is applied.

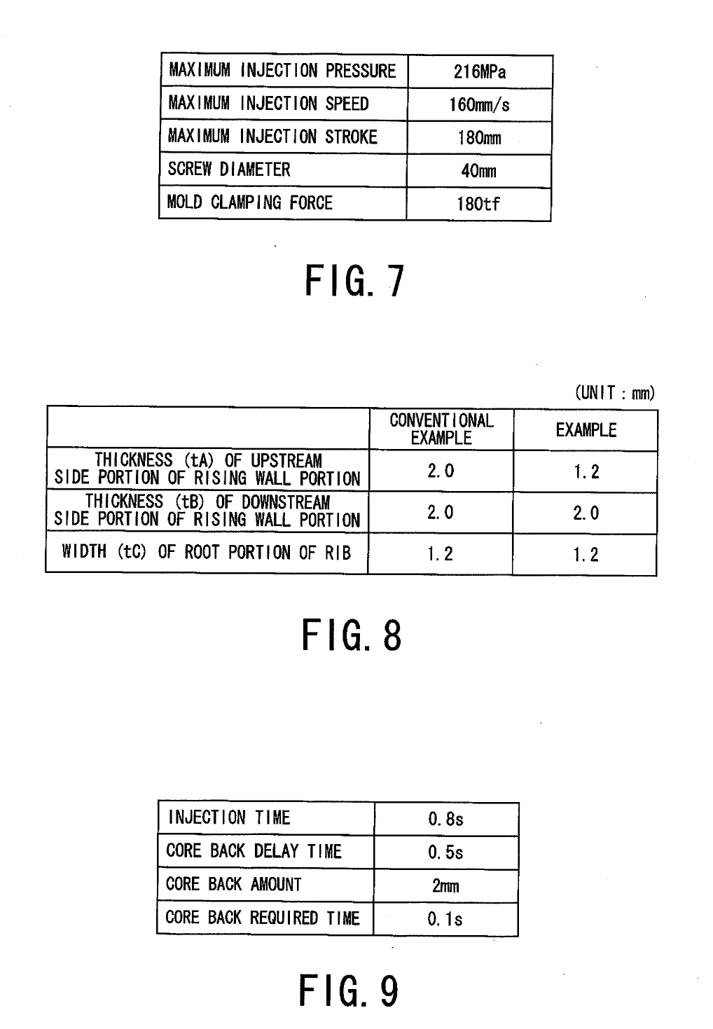

In both Example and Conventional Example, the same resin material is used, and the resin material is polypropylene to which a chemical foaming agent is added. Regarding to an injection molding machine, the same injection molding machine having specifications shown in FIG. 7 is used for both Example and Conventional Example.

Further, as to a molding die to be used in both Example and Conventional Example, the molding die having a cavity is used, and the cavity is formed so that a foam-molded product having a shape and size shown in FIG. 8 can be molded.

Namely, the thickness tA of the upstream side portion of the rising wall portion is set to be 1.2 mm for Example (tA=1.2 mm), and the thickness tA is set to be 2.0 mm for Comparative Example (tA=2.0 mm). While, the thickness tB of the downstream side portion 4B of the rising wall portion is set to 2.0 mm for both Example and Conventional Example (tB=2.0 mm). Further, a width tC of a root portion of the rib is set to 1.2 mm for both Example and Conventional Example (tC=1.2 mm).

In the injection foam-molding process for both Example and Conventional Example, the following operations were performed. Namely, after completion of die clamping operation shown in FIG. 2, the resin material to which the chemical foaming agent was added was injected into the cavity of the molding die, and the cavity was filled with the resin material as shown in FIG. 3. After completion of the resin-filling operation, a core back operation was performed under the conditions shown in FIG. 9. Then, after cooling the injected resin material, a foam-molded product was taken out from the molding die.

In this connection, a core back delay time indicated in FIG. 9 is a waiting time ranging from a time when the injection is completed to a time when the core back operation is started. This core back delay time is set for performing the core back operation after a skin layer is formed on a surface of the resin material injected into the cavity.

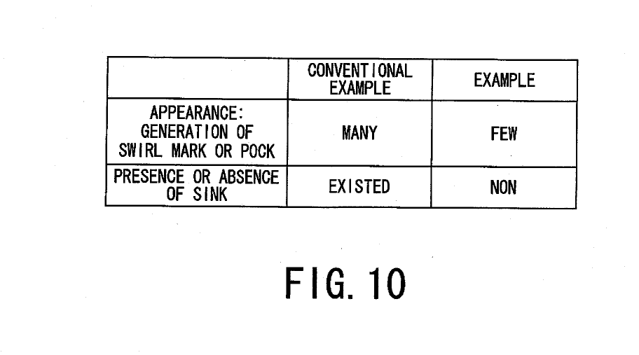

Circumstances of appearance and sink of the foam-molded products molded and taken out from the molding die are indicated in FIG. 10. In the form-molded product according to Conventional Example, as shown in FIG. 6B, many swirl marks or pock marks (pits) were generated particularly at the region of the upstream side portion 6A (a portion ranging from the gate 15 to the rib 5) in the rising wall portions 6, while sinks 7 were generated at portions close to the ribs 5 in the downstream side portion 6B (a portion ranging from the rib 5 to a portion extending in a direction opposing to the gate 15 side).

In contrast, in the form-molded product according to Example, the generation of the swirl marks or pock marks (pits) generated at the upstream side portion 4A of the rising wall portion 4 shown in FIG. 6A was effectively reduced. Further, the sink 7 was not generated at all at a portion close to the rib 5 provided in the downstream side portion 4B of the rising wall portion 4.

According to the present embodiment configured as described above, the following advantageous effects can be exhibited. Namely, the resin material 1 in molten state to which the foaming agent is added is injected into the cavity 14 of the molding die 10 through a gate 15 whereby the foam-molded product 2 comprising the bottom surface portion 3 and the rising wall portion 4 rising from the bottom surface portion 3 is molded. In this foam-molding process, the gate 15 communicated with the cavity 14 is continuously formed to the rising wall portion 4 of the foam-molded product 2; and the rising wall portion 4 is provided with the rib 5 at a position apart from the gate 15 at predetermined distance, and a thickness to of an upstream side portion 4A ranging from the gate 15 to the rib 5 is thinner than a thickness tB of a downstream side portion 4B ranging from the rib 5 and extending in a direction opposing to the gate 15. Namely, the relation of (tA<tB) is established.

Accordingly, as to the resin material 1 in a molten state which is injected from the gate 15 into the cavity 14, a foaming (foam formation) of the resin material 1 can be effectively suppressed in a region corresponding to the upstream side portion 4A of the rising wall portion 4 of the foam-molded product 2. In contrast, the foaming of the resin material 1 can be effectively promoted in a region corresponding to the downstream side portion 4B of the rising wall portion 4.

As a result, the resin material 1 effectively foams at root portion of the rib 5, so that it becomes possible to prevent the generation of the sink 7 to a portion close to the rib 5 in the rising wall portion 4 of the foam-molded product 2, and it becomes also possible to prevent the generation of the swirl mark or the pock mark to the upstream side portion 4A in the rising wall portion 4 of the foam-molded product 2.

Although the present invention has been explained with reference to the preferred embodiments, it should be understood that the present invention is not limited to the preferred embodiment described above, and many other modifications and changes may be made without departing from the scope of the appended claims. For example, the present invention can be also applied to a case where a resin molded product provided with a rib is injection-molded, by using a resin material to which a foaming agent is added, and without performing a core-back process. Namely, the present invention can be also applied to a case where the core-back process is omitted in the molding method shown in FIGS. 1A-1E.

1. A method of molding a resin molded product in which a resin material in a molten state containing a forming agent is injected through a gate into a cavity of molding die thereby to form the resin molded product,
wherein said gate communicating with the cavity of the molding die is continuously formed to a portion of the resin molded product; the resin molded product is provided with a rib at a position apart from the gate at predetermined distance, and a thickness of an upstream side portion ranging from the gate to the rib is thinner than a thickness of a downstream side portion ranging from the rib and extending in a direction opposing to the gate; and
a foaming of the molten resin material injected from the gate into the cavity is suppressed at a region corresponding to the upstream side portion of the resin molded product, while the foaming of the molten resin material is promoted at a region corresponding to the downstream side portion of the resin molded product.

2. The method of molding a resin molded product of claim 1, wherein the molding die comprises a fixed die and a movable die which is movable with respect to the fixed die, the cavity is formed at a portion between the fixed die and the movable die, the resin material in a molten state is injected into the cavity, thereafter, the movable die is pulled apart from the fixed die at a predetermined distance, so that the resin material is foamed by the foaming agent thereby to form the resin molded product;
said resin molded product has a box-shape comprising a bottom surface portion and rising wall portions, and the rising wall portions are provided so as to rise from the bottom surface portion in parallel with a pulling apart-direction of the movable die;
wherein said gate communicating with the cavity is continuously formed to the rising wall portion;
the rising wall portions are provided with a rib at a position apart from the gate at predetermined distance, and a thickness of an upstream side portion ranging from the gate to the rib is thinner than a thickness of a downstream side portion ranging from the rib and extending in a direction opposing to the gate.

3. The method of molding a resin molded product of claim 1, wherein the resin molded product is molded in the cavity under a condition that the thickness of the upstream side portion of the resin molded product or the rising wall portion is set to be larger than a width of the root portion of the rib.

4. The method of molding a resin molded product of claim 1, wherein the resin molded product is molded in the cavity under a condition that a difference between the thickness of the upstream side portion of the resin molded product or the rising wall portions and a thickness of the downstream side portion is set to be 0.5 mm or more.

5. The method of molding a resin molded product of claim 1, wherein the resin molded product is molded in the cavity under a condition that the thickness of the upstream side portion of the resin molded product or the rising wall portion is set to be 1.5 mm or less.
